(19) United States
(12) Patent Application Publication
(10) Pub. No.: US 2023/0158375 A1
(43) Pub. Date: May 25, 2023

(54) Golf Club and Integrated Bottle Opener

(71) Applicant: David Matthew Reed, New York, NY (US)

(72) Inventor: David Matthew Reed, New York, NY (US)

(21) Appl. No.: 17/534,521

(22) Filed: Nov. 24, 2021

(51) Int. Cl. A63B 53/04; B67B 7/16

(52) U.S. Cl. CPC A63B 53/0487; B67B 7/16; A63B 2209/08

(57) ABSTRACT

The present disclosure provides a golf club and golf club head which integrate a bottle opener mechanism onto a rear wall of the head so as to provide bottle cap removal functionality without interfering with the shape that allows players to scoop balls from the ground without bending down. The golf club head may also have a permanent magnet disposed adjacent to the bottle opener mechanism to prevent removed bottle caps from falling to the ground.

### FIELD OF INVENTION

The present invention relates generally to golf clubs. More specifically, the present invention relates to a golf club head having an integrated bottle cap opening mechanism.

### BACKGROUND

Golf is a highly popular leisure activity typically played outdoors, and often for long periods of time in good weather conditions. It is common for groups of four or more to make an outing of the activity, spending large portions of weekends playing the game with friends and there is a tendency for such groups to enjoy beverages such as soda and beer while out on the course. These beverages are often referred to as “swing lube”, as many players feel it loosens up their swing and leads to an improved round and score.

A problem is that many beverage bottles are capped with bottle caps that are difficult to remove without a dedicated bottle opener. There are plenty of bottle cap openers and removers on the market, but many of these are small, individual items. Before, during, and after a round of golf, players are constantly opening and closing pockets within their golf bag to retrieve balls, tees, and other items. Combined with the quick movement and turn of a golf cart, it is extremely easy to lose small, individual items, such as bottle openers, during a round of golf. It would greatly increase the convenience for golf players if a bottle opener could be integrated with an item they were already carrying, i.e. a golf club.

One such solution is disclosed by U.S. Pat. No. 7,658,130B1, which described a bottle cap removal structure in the rear surface of a golf club head. While convenient for opening beverages, the disclosed removal structure is formed of an extrusion that is substantially parallel to the club face rear wall.

This is a change from standard putter design and furthermore interferes with one of the more well-known design features of putters—the ability of a player to easily scoop a golf ball from the ground without bending down, using the cavity in the rear of the putter head. The extrusion creates an obstacle to this function, not allowing a golf ball to be scooped onto the back of the putter and raised into the golfer's hand. Furthermore, there is no mechanism in the prior art golf head for preventing the bottle cap from falling to the ground once it has been removed from the bottle.

Given that many players are in their later years and wish to avoid bending down unnecessarily, and that the prior art golf head design is intended for convenience, there is a need for an improved golf head design that circumvents these issues. It is within this context that the present invention is provided.

### SUMMARY

The present disclosure provides a golf club and golf club head which integrate a bottle opener mechanism onto a rear wall of the head so as to provide bottle cap removal functionality without interfering with the shape that allows players to scoop balls from the ground without bending down. The golf club head may also have a permanent magnet disposed adjacent to the bottle opener mechanism to prevent removed bottle caps from falling to the ground.

Thus, according to one aspect of the present disclosure there is provided a golf club comprising a shaft and a golf club head, the golf club head having a front face configured for striking a golf ball; an opposing rearward face oriented parallel to the front face and a base portion extending perpendicularly from the rearward face to form a cavity configured to receive a golf ball; wherein the rearward face has disposed thereon a bottle opener mechanism.

In some embodiments, the bottle opener mechanism comprises an edged protrusion extending from the rearward face to from a trapping space between the protrusion and the base portion.

The protrusion may extend at an acute angle from the rearward face, being inclined towards the base portion.

Furthermore, in some embodiments, the edge of the protrusion forms a sharp corner or hook for gaining purchase on a bottle cap.

In some embodiments, a permanent magnet is disposed between the base portion and the bottle opener mechanism.

In some embodiments, the golf club is a putter.

According to another aspect of the present disclosure there is provided a golf club head having a front face configured for striking a golf ball; an opposing rearward face oriented parallel to the front face and a base portion extending perpendicularly from the rearward face to form a cavity configured to receive a golf ball; wherein the rearward face has disposed thereon a bottle opener mechanism.

The bottle opener mechanism may comprise an edged protrusion extending from the rearward face to from a trapping space between the protrusion and the base portion.

In some embodiments, the protrusion extends at an acute angle from the rearward face, being inclined towards the base portion.

In some embodiments, the edge of the protrusion forms a sharp corner or hook for gaining purchase on a bottle cap.

In some embodiments, a permanent magnet is disposed between the base portion and the bottle opener mechanism.

In some embodiments, the golf club head is a putter head.

### BRIEF DESCRIPTION OF THE DRAWINGS

Various embodiments of the invention are disclosed in the following detailed description and accompanying drawings.

FIG. 1 illustrates an isometric view of an example configuration of a golf club head and integrated bottle opener mechanism according to the present disclosure.

FIG. 2 illustrates a cross-sectional view of the golf club head configuration of FIG. 1 along the line X-X.

FIG. 3 illustrates a second cross-sectional view of the golf club head configuration in position for removing a bottle cap from a bottle.

FIG. 4 illustrates the cross-sectional view of FIG. 3 where torque has been applied to the golf club head or the bottle to remove the bottle cap.

FIG. 5 illustrates the same cross-sectional view where the bottle has been removed and the permanent magnet embedded in the golf club head has prevented the removed bottle cap from falling to the ground.

FIG. 6 illustrates an isometric view of the configuration of the golf club head and integrated bottle opener mechanism performing a standard scooping function to pick up a golf ball from the ground without interference.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

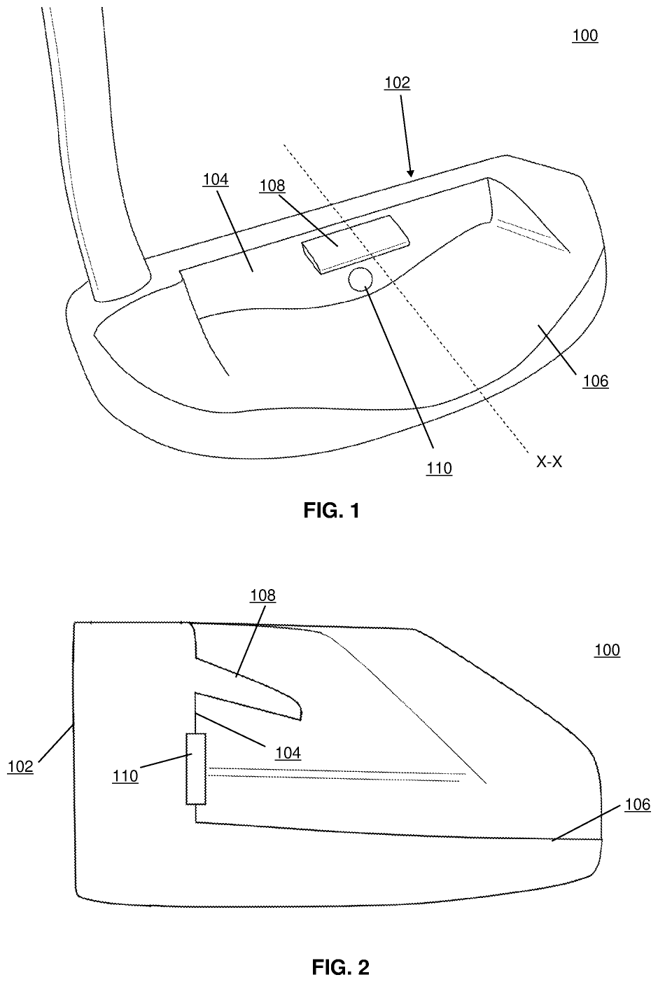

Referring to FIG. 1, an example configuration of a golf club head 100 is shown.

The club head is a putter, and has a flat front surface 102 for striking golf balls as is standard in putter design. The opposing rearward surface 104 forms a cavity with a curved base portion 106 that protrudes perpendicularly from the rearward face and curves down to a thin edge in the middle, allowing the base portion to be slid underneath a golf ball on the ground so that a player can easily flick the ball up and catch it without having to bend down.

A bottle opening mechanism 108 is disposed on the rearward surface 104. In the present example, the bottle opener mechanism 108 is an edged protrusion that extends outwards from the rearward face 104 at an acute angle from the rearward face with respect to the surface of the base portion 106. The protrusion 108, in addition to be angled downwards like this has a sharp or hooked edge that allows the lip of a bottle cap to be wedged against it.

The distance between the base portion surface 106 and the protrusion 108 is greater than the height of a standard bottle cap and the width of the surface of the base portion 106 is controlled such that a bottle cap that has one edge wedged against protrusion 108 will have the opposing corner rest against base portion 106.

A permanent magnet 110 may also be included in the space on the rearward wall 104 between the bottle opener mechanism 108 and the base portion 106. The magnet can either be adhered to the surface or embedded within the rearward wall 104. It acts to apply an attractive force to metallic bottle caps that have been removed from their respective bottles such that following a bottle opening action, the cap does not fall to the ground and force the user to bend to pick it up.

This bottle opening operation is illustrated and described further with respect to FIGS. 2-5, which each show cross sectional views of the golf club head along the plane X-X.

Thus, referring to FIG. 2, a cross-sectional view of the golf club head 100 is shown in an upright position, i.e. the position in which it would be used to strike a golf ball.

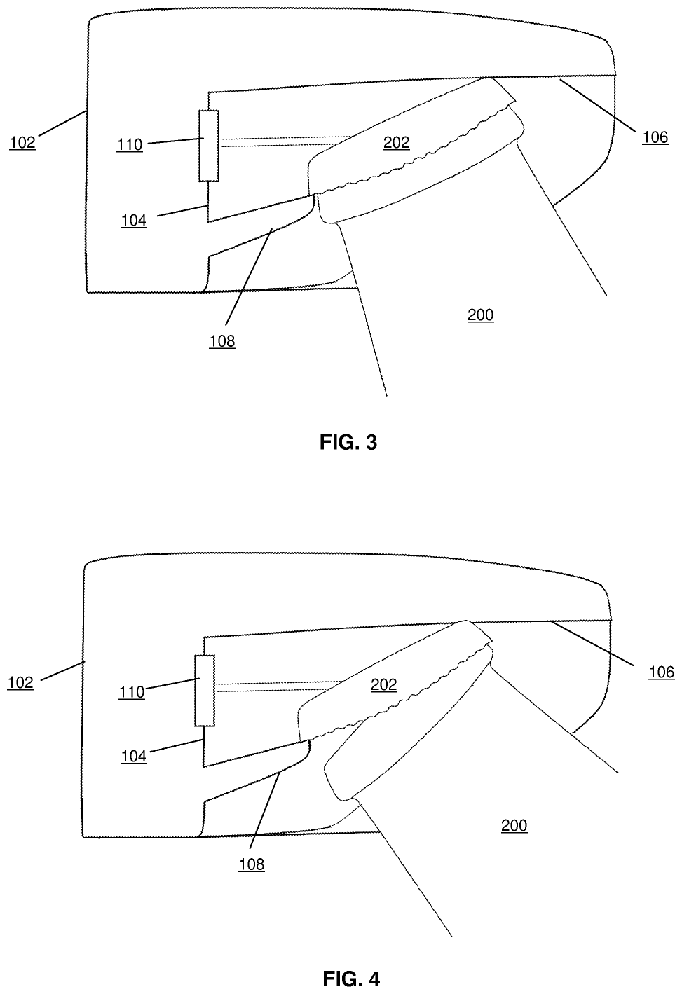

The following FIGS. 3-5 show a bottle opening operation where the golf club head 100 has been turned upside down in order to wedge the cap 202 of a bottle 200 between protrusion 108 and base portion 106 in a more ergonomic position for a user.

FIG. 3 shows the bottle 200 with its cap 202 still on having been placed in position for opening by mechanism 108. As described above, the lip of one side of the cap 202 rests against the sharp/hooked edge of protrusion 108, while the opposing corner of the cap 202 rests against base portion surface 106.

A user then holds the bottle in one hand and the handle of the golf club in the other and applies a relative torque between them to lever the cap away from the bottle. This can be done either by applying a clockwise torque to the golf club head 100 via the handle and holding the bottle 200 still, applying an anti-clockwise torque to the bottle while holding the golf club head 100 still, or a combination of both.

As shown in FIG. 4, these actions cause the trapped lip of the bottle cap 202 to be prised away from the bottle opening by the protrusion 108.

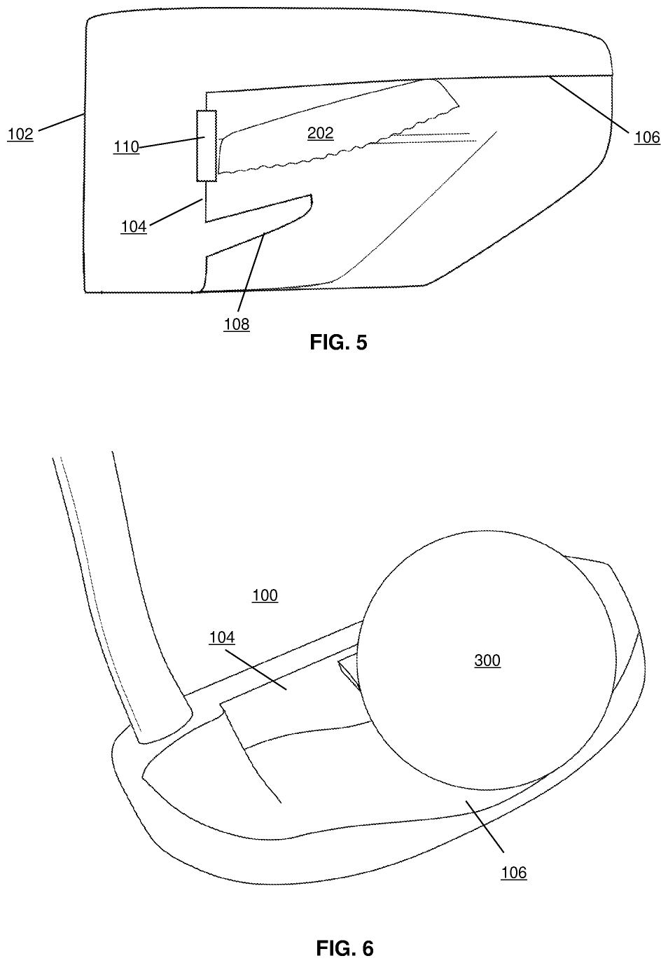

FIG. 5 illustrates the above-described effect of the permanent magnet 110 disposed in rearward wall 104. As mentioned, the attractive force of the magnet causes the bottle cap 202 to adhere to the rearward wall 104 instead of falling to the ground following removal of the cap from the bottle 200. A player may then raise the club head 100 to within reach, pick the cap 202 from the club head, and dispose of it at their leisure.

As mentioned above, the design of the disclosed golf club head 100 and bottle opener mechanism 108 allow for the scooping action employed by players using standard putter heads to pick golf balls up off the ground without bending down to still be used.

As illustrated in FIG. 6, the protrusion, or indeed any other type of bottle opener mechanism 108 disposed on the rearward wall 104 of the golf club head 100, can be sized so as to allow a golf ball 300 to rest comfortably on the cavity formed by the base portion and the rearward wall without obstruction.

If necessary, the protrusion 108 can also be provided even lower on the rearward surface 104, so long as it rests, at its closest point, at a distance away from the base portion surface 106 that is greater than a standard bottle cap height.

It should also be noted that the disclosed example design also uses less material and is thus cheaper to manufacture than that of the prior art solutions, given that a standard putter golf head design is used with only a small protrusion/bottle opener mechanism added to the rearward wall. The feel and look of a classic putter golf head are also replicated.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the golf club and golf club head have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A golf club comprising a shaft and a golf club head, the golf club head having a front face configured for striking a golf ball; an opposing rearward face oriented parallel to the front face and a base portion extending perpendicularly from the rearward face to form a cavity configured to receive a golf ball; wherein the rearward face has disposed thereon a bottle opener mechanism.

2. A golf club according to claim 1, wherein the bottle opener mechanism comprises an edged protrusion extending from the rearward face to from a trapping space between the protrusion and the base portion.

3. A golf club according to claim 2, wherein the protrusion extends at an acute angle from the rearward face, being inclined towards the base portion.

4. A golf club according to claim 2, wherein the edge of the protrusion forms a sharp corner or hook for gaining purchase on a bottle cap.

5. A golf club according to claim 1, wherein a permanent magnet is disposed between the base portion and the bottle opener mechanism.

6. A golf club according to claim 1, wherein the golf club is a putter.

7. A golf club head, the golf club head having a front face configured for striking a golf ball; an opposing rearward face oriented parallel to the front face and a base portion extending perpendicularly from the rearward face to form a cavity configured to receive a golf ball; wherein the rearward face has disposed thereon a bottle opener mechanism.

8. A golf club head according to claim 7, wherein the bottle opener mechanism comprises an edged protrusion extending from the rearward face to from a trapping space between the protrusion and the base portion.

9. A golf club head according to claim 8, wherein the protrusion extends at an acute angle from the rearward face, being inclined towards the base portion.

10. A golf club head according to claim 8, wherein the edge of the protrusion forms a sharp corner or hook for gaining purchase on a bottle cap.

11. A golf club head according to claim 7, wherein a permanent magnet is disposed between the base portion and the bottle opener mechanism.

12. A golf club head according to claim 7, wherein the golf club head is a putter head.
